(19) United States
(12) Patent Application Publication
(10) Pub. No.: US 2026/0229208 A1
(43) Pub. Date: Aug. 6, 2026

(54) PIEZOELECTRIC ELEMENT, ELECTRONIC PERCUSSION INSTRUMENT, AND METHOD FOR MANUFACTURING PIEZOELECTRIC ELEMENT AND ELECTRONIC PERCUSSION INSTRUMENT

(71) Applicant: Roland Corporation, Shizuoka (JP)

(72) Inventor: Ryoken Watanabe, Shizuoka (JP)

(73) Assignee: Roland Corporation, Shizuoka (JP)

(21) Appl. No.: 19/438,680

(22) Filed: Jan. 2, 2026

(30) Foreign Application Priority Data
Jan. 31, 2025 (JP) 2025-015304

(51) Int. Cl. G10H 3/14; G10D 13/10

(52) U.S. Cl. CPC G10H 3/143; G10D 13/26; G10H 2220/525

(57) ABSTRACT

A piezoelectric element, an electronic percussion instrument, and a method for manufacturing a piezoelectric element and an electronic percussion instrument are capable of suppressing a decrease in detection sensitivity of striking.

A protective film covers an upper electrode of a piezoelectric element and is formed using a material capable of suppressing gas permeation (for example, a resin material such as rosin), so that contact between gas surrounding the upper electrode and the upper electrode can be blocked by the protective film. As a result, even in the case where a cover covering the piezoelectric element is made of rubber, reaction between sulfur volatilized from the cover and silver contained in the upper electrode can be suppressed, so that deterioration of the upper electrode can be suppressed. Therefore, a decrease in sensitivity of the piezoelectric element to striking on a frame can be suppressed.

### CROSS-REFERENCE TO RELATED APPLICATION

This application claims the priority benefits of Japanese application no. 2025-015304, filed on Jan. 31, 2025. The entirety of the above-mentioned patent application is hereby incorporated by reference herein and made a part of this specification.

### BACKGROUND

### Technical Field

The disclosure relates to a piezoelectric element, an electronic percussion instrument, and a method for manufacturing a piezoelectric element and an electronic percussion instrument, and more particularly to a piezoelectric element, an electronic percussion instrument, and a method for manufacturing a piezoelectric element and an electronic percussion instrument capable of suppressing a decrease in detection sensitivity of striking.

### Description of Related Art

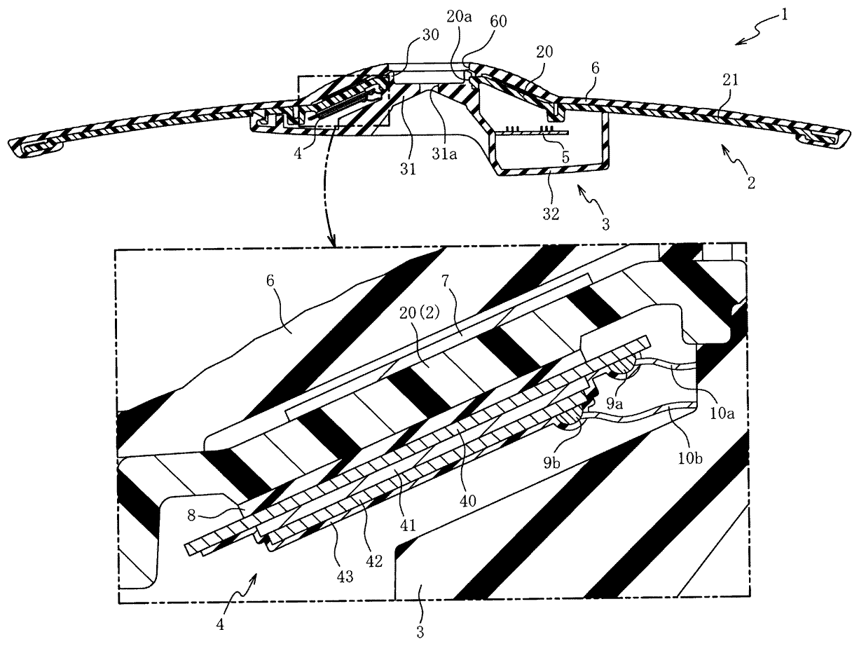

For example, Patent Document 1 (Japanese Patent Application Laid-Open No. 2023-146962 (for example, paragraphs 0013 to 0017 and FIG. 1)) describes a technology in which a case 3 is fixed to a lower surface of a frame 2 that forms a skeleton of an electronic cymbal 1, and a striking sensor is housed in a space inside the case 3. The striking sensor is a piezoelectric element that detects vibration when the frame 2 is struck. This type of piezoelectric element mainly includes a lower electrode, a piezoelectric body stacked on the lower electrode, and an upper electrode stacked on the piezoelectric body, and the upper electrode generally contains silver.

Although the above-mentioned Patent Document 1 does not describe a specific material of the case 3, for example, Patent Document 2 (Japanese Patent Application Laid-Open No. 2021-026077 (for example, paragraph 0013 and FIG. 2)) describes a technology in which rubber is used as a material of the case 8. In the case where the case covering the piezoelectric element is made of rubber, silver of the upper electrode may be sulfurized by sulfur volatilized from the case (rubber), and in the case where the upper electrode deteriorates due to such sulfurization, the detection sensitivity of striking by the piezoelectric element decreases.

The disclosure provides a piezoelectric element, an electronic percussion instrument, and a method for manufacturing a piezoelectric element and an electronic percussion instrument capable of suppressing a decrease in detection sensitivity of striking.

### SUMMARY

A piezoelectric element of the disclosure is a piezoelectric element attached to an electronic percussion instrument, including a lower electrode, a piezoelectric body stacked on the lower electrode, an upper electrode stacked on the piezoelectric body, and a protective film that covers the upper electrode and protects the upper electrode from gas surrounding the upper electrode.

An electronic percussion instrument of the disclosure includes the piezoelectric element of the disclosure and a rubber cover that covers a space in which the piezoelectric element is housed, and a strike is detected based on an output value of the piezoelectric element.

A method for manufacturing a piezoelectric element of the disclosure is a method for manufacturing a piezoelectric element attached to an electronic percussion instrument, including a lamination process in which a laminate in which a lower electrode, a piezoelectric body stacked on the lower electrode, and an upper electrode stacked on the piezoelectric body are stacked is formed, and a coating process in which the upper electrode of the laminate formed in the lamination process is coated with a protective film for protecting the upper electrode from gas surrounding the upper electrode.

A method for manufacturing an electronic percussion instrument of the disclosure is a method for manufacturing an electronic percussion instrument including a housing and a piezoelectric element attached to the housing, including a lamination process in which a laminate in which a lower electrode, a piezoelectric body stacked on the lower electrode, and an upper electrode stacked on the piezoelectric body are stacked is formed, a coating process in which the piezoelectric element is formed by coating the upper electrode of the laminate formed in the lamination process with a protective film for protecting the upper electrode from gas surrounding the upper electrode, and a mounting process in which the piezoelectric element formed in the coating process is attached to the housing.

### BRIEF DESCRIPTION OF THE DRAWINGS

The FIGURE is a cross-sectional view of an electronic cymbal according to an embodiment.

### DESCRIPTION OF THE EMBODIMENTS

Hereinafter, exemplary embodiments are described with reference to the accompanying drawings. The FIG. 1s a cross-sectional view of an electronic cymbal 1 in according to an embodiment. Note that The FIGURE illustrates a cross-section (partially an end surface) cut along a plane along the central axis of a disc-shaped frame 2.

As shown in the FIGURE, the electronic cymbal 1 is an electronic percussion instrument imitating an acoustic cymbal, and the skeleton of the electronic cymbal 1 is formed by the frame 2. The frame 2 includes a bell portion 20 imitating the shape of a bell of a cymbal and a bow portion 21 imitating the shape of a bow of a cymbal, and each of the portions 20 and 21 is integrally formed using a resin material.

The bell portion 20 is formed in a bowl shape that slopes downward from a central side thereof toward an outer peripheral side, and the bow portion 21 extends toward the outer peripheral side from an outer edge of the bell portion 20. The bow portion 21 slopes downward more gently toward the outer peripheral side than the bell portion 20, and the frame 2 is formed in a substantially disc-shaped as a whole by the bell portion 20 and the bow portion 21.

A through hole 20a is formed in the center of the bell portion 20, and a cover 3 is attached to the through hole 20a. The cover 3 is a member that constitutes a housing of the electronic cymbal 1 together with the striking surface frame 2. The cover 3 includes a substantially cylindrical inner wall portion 30, and the inner wall portion 30 is hooked on the edge of the through hole 20a of the bell portion 20. The inner peripheral side of the inner wall portion 30 is closed by a disc-shaped support portion 31 having a through hole 31a in the center, and a rod (not shown) for supporting the electronic cymbal 1 is inserted into the through hole 31a of the support portion 31.

A bottom wall portion 32 extends toward the outer peripheral side from the lower end of the inner wall portion 30, and by fixing the outer edge of the bottom wall portion 32 to the lower surface of the frame 2 (bow portion 21), a space surrounded by the frame 2 and the cover 3 is formed on the lower surface side of the frame 2. In the space, electronic components such as a piezoelectric element 4 attached to the lower surface of the bell portion 20 and a substrate 5 are housed. The piezoelectric element 4 is a sensor that detects vibration of the frame 2, and based on an output value output by the piezoelectric element 4, the presence or absence and intensity of a strike on the bow portion 21 are detected.

The upper surface of each of the bell portion 20 and the bow portion 21 of the frame 2 is covered by a rubber upper cover 6 having a through hole 60 in the center, and the upper cover 6 is formed in a shape (substantially disc-shaped) that follows each of the portions 20 and 21 of the frame 2. A sensor 7 (see the enlarged portion in the FIGURE) for detecting a strike on the bell portion 20 is attached between the bell portion 20 and the upper cover 6.

The sensor 7 is a sheet-shaped pressure-sensitive sensor (for example, a membrane switch) that turns ON/OFF at the time of striking the upper cover 6 covering the bell portion 20. The strike detected by the piezoelectric element 4 and the sensor 7 is converted into an electrical signal and output to a sound source device (not shown). As a result, a musical tone corresponding to the striking position on the electronic cymbal 1 is generated.

As shown in the enlarged portion of the FIGURE, the piezoelectric element 4 includes a lower electrode 40 that is adhered to the lower surface of the bell portion 20 by a double-sided tape 8 having cushioning properties, a piezoelectric body 41 stacked on the lower electrode 40, an upper electrode 42 stacked on the piezoelectric body 41, and a protective film 43 covering the upper surface of the upper electrode 42. In the example shown in the enlarged portion of the FIGURE, the upper surface of the upper electrode 42 is a surface facing the lower side of the electronic cymbal 1, and the same applies to the upper surface of each of portions of the piezoelectric element 4 described below.

The lower electrode 40 is formed in a disc shape using a metal material, and the piezoelectric body 41 is adhered to the upper surface of the lower electrode 40 by a conductive adhesive or the like. The piezoelectric body 41 is formed in a disc shape using a material such as ceramics that exhibits a piezoelectric effect, and the upper electrode 42 of a disc shape is formed on the upper surface of the piezoelectric body 41 by applying (printing) a conductive paste containing silver. The diameter of the upper electrode 42 is formed smaller than the diameter of the piezoelectric body 41, and the diameter of the piezoelectric body 41 is formed smaller than the diameter of the lower electrode 40.

Since the cover 3 covering the piezoelectric element 4 is made of rubber, sulfur used during vulcanization molding of the cover 3 may remain in the cover 3. When the sulfur volatilizes from the cover 3, the silver contained in the upper electrode 42 reacts with the sulfur, and the upper electrode 42 tends to deteriorate. In the embodiment, the deterioration of the upper electrode 42 is suppressed by the protective film 43.

The protective film 43 is formed using a material capable of suppressing gas permeation (for example, a resin material such as rosin), and although not shown in the drawings, the entire upper surface of the upper electrode 42 is covered (over the entire surface) by the protective film 43. In addition, the entire circumference of the outer peripheral surface of the upper electrode 42 is also covered by the protective film 43.

In this manner, by covering the entire upper electrode 42 with the protective film 43, contact between the gas surrounding the upper electrode 42 and the upper electrode 42 can be blocked by the protective film 43. As a result, even in the case where the cover 3 covering the piezoelectric element 4 is made of rubber, the reaction between the sulfur volatilized from the cover 3 and the silver contained in the upper electrode 42 can be suppressed, so that deterioration of the upper electrode 42 can be suppressed. Therefore, a decrease in the sensitivity of the piezoelectric element 4 to striking on the frame 2 (vibration of the frame 2) can be suppressed.

In the embodiment, a case where the silver of the upper electrode 42 deteriorates due to sulfur contained in the cover 3 is illustrated as an example, but for example, the upper electrode 42 may contain a metal material other than silver (for example, copper, nickel, palladium, etc.). In addition, the metal contained in the upper electrode 42 may deteriorate not only due to sulfurization by sulfur but also due to oxidation or the like. Even in the case where the upper electrode 42 is formed of such a material other than silver, or in the case where the piezoelectric element 4 is placed in an environment where deterioration due to factors other than sulfurization is expected, it is preferable to form the protective film 43 as in the embodiment. As a result, deterioration of the upper electrode 42 can be suppressed.

The details of the method for forming the protective film 43 on the upper electrode 42 are described later, but the protective film 43 is formed by applying flux having rosin as a main component (main agent). Therefore, the main component of the protective film 43 is also rosin (95 wt % or more of the protective film 43 is rosin). Since rosin has lower gas permeability compared to resins such as silicone, for example, by covering the upper electrode 42 with the protective film 43 having rosin as a main component, deterioration of the upper electrode 42 can be effectively suppressed.

The thicker the protective film 43 covering the upper electrode 42, the more contact between the outside air containing sulfur and the like and the upper electrode 42 can be suppressed. On the other hand, if the protective film 43 is too thick, the detection sensitivity of vibration by the piezoelectric element 4 may decrease. Therefore, the thickness of the protective film 43 is preferably 4 μm or more and 30 μm or less, and more preferably 10 μm or more and 25 μm or less.

By forming the protective film 43 with such a thickness, the protective film 43 can be formed with a thickness sufficient to prevent contact between the outside air containing sulfur and the like and the upper electrode 42, while a decrease in the detection sensitivity of vibration of the piezoelectric element 4 due to the protective film 43 is suppressed. Therefore, while deterioration of the upper electrode 42 is suppressed, striking on the frame 2 can be detected with high accuracy by the piezoelectric element 4.

A conductor wire 10a is connected to the lower electrode 40 by solder 9a, and a conductor wire 10b is connected to the upper electrode 42 by solder 9b. Although not illustrated, the two conductor wires 10a and 10b are connected to each of the lower electrode 40 and the upper electrode 42. A signal (voltage) generated in the piezoelectric element 4 at the time of striking the frame 2 is output to the substrate 5 through the conductor wire 10a and the conductor wire 10b. The solder 9a and the solder 9b are covered with the protective film 43 over the entire upper surfaces thereof (over the entire surfaces).

In this manner, by covering the entire upper electrode 42 including the connection portion between the upper electrode 42 and the conductor wire 10b (the upper surface of the solder 9b) with the protective film 43, contact between the outside air containing sulfur and the like and the upper electrode 42 can be reliably prevented. Therefore, deterioration of the upper electrode 42 can be effectively suppressed.

Next, a method for manufacturing the piezoelectric element 4 (electronic cymbal 1) is described. When manufacturing the piezoelectric element 4, first, a laminate in which the lower electrode 40, the piezoelectric body 41, and the upper electrode 42 are stacked is created (lamination process), and then, the conductor wire 10a and the conductor wire 10b are soldered to the lower electrode 40 and the upper electrode 42 of the laminate (connection process). After connecting the conductor wire 10a and the conductor wire 10b to the upper and lower electrodes 40 and 42, the protective film 43 covering the entire upper electrode 42 is formed by applying flux to the upper electrode 42 (coating process). The piezoelectric element 4 is manufactured through the process of forming the protective film 43, and then, the manufactured piezoelectric element 4 is attached to the lower surface of the frame 2 (mounting process). Then, the electronic cymbal 1 is manufactured by attaching the cover 3 covering the piezoelectric element 4 to the lower surface side of the frame 2.

For the flux applied to the upper electrode 42 described above, it is preferable to use commercially available resin-based flux having rosin and solvent as main components. Since such resin-based flux has appropriate fluidity (viscosity) that allows the resin-based flux to be uniformly spread on the upper surface of the upper electrode 42, workability of the operation of forming the protective film 43 on the upper electrode 42 can be improved. In addition, by using the commercially available resin-based flux as described above, since it is not required to apply a special sulfurization-resistant coating to the upper electrode 42, the protective film 43 can be formed at low cost.

As such commercially available flux, flux for electronic components containing 45 to 55 wt % of isopropyl alcohol (solvent), 25 to 35 wt % of rosin (rosin), 10 to 20 wt % of methanol (solvent), and 1 to 10 wt % of ethyl acetate (solvent) is exemplified.

As with the flux (composed of 100 wt % by rosin and solvent), it is preferable to form the protective film 43 with flux containing 20 to 40 wt % of rosin and 60 to 80 wt % of solvent, and it is more preferable to form the protective film 43 with flux containing 25 to 35 wt % of rosin and 65 to 75 wt % of solvent. Flux having such components excels in fluidity when spreading on the upper electrode 42 as described above, and also excels in quick-drying properties, so that the operation of forming the protective film 43 on the upper electrode 42 can be performed efficiently.

In the case of forming the protective film 43 by applying flux to the upper electrode 42, it is also probable to solder the conductor wire 10a and the conductor wire 10b after applying the flux to the upper electrode 42, for example. However, in order to form the protective film 43 with a film thickness sufficient to adequately protect the upper electrode 42 from outside air containing sulfur and the like, it is required to apply the flux relatively thickly, so in a configuration in which the conductor wire 10b is connected to the upper electrode 42 after the flux is applied, it may become difficult to appropriately solder the conductor wire 10b to the upper electrode 42.

In contrast, as in the embodiment, in a configuration in which the flux is applied to the upper electrode 42 after soldering the conductor wire 10b to the upper electrode 42, the conductor wire 10b can be soldered without being affected by the flux. Therefore, since the conductor wire 10b can be appropriately soldered to the upper electrode 42, it is probable to suppress the occurrence of conduction failure and the like at the connection portion between the upper electrode 42 and the conductor wire 10b, for example, and after the conductor wire 10b is soldered, the protective film 43 can be formed with a thickness sufficient to adequately protect the upper electrode 42. Therefore, it is probable to suppress deterioration of the upper electrode 42 during use of the piezoelectric element 4 while suppressing degradation in quality during manufacturing of the piezoelectric element 4.

Here, in the embodiment, the protective film 43 is formed not only on the entire upper electrode 42 (solder 9b) but also on the lower electrode 40, the solder 9a, and the piezoelectric body 41. That is, substantially the entire upper surface of the piezoelectric element 4 is covered with the protective film 43, but since the rosin, which is the main component of the protective film 43, does not have conductivity, even in the case of forming the protective film 43 on each of the upper and lower electrodes 40 and 42, the insulated state between the electrodes 40 and 42 can be ensured. In other words, when applying the flux to form the protective film 43, even if the flux protrudes to the outer peripheral side beyond the piezoelectric body 41 or the upper electrode 42, short-circuiting of the upper and lower electrodes 40 and 42 by the protective film 43 can be suppressed.

In this way, by forming the protective film 43 using a material having insulating properties, high precision is not required for the operation of forming the protective film 43 (applying the flux). Therefore, since the protective film 43 can be easily formed, for example, in the case of forming the protective film 43 by manual work, the workability can be improved. In addition, in the case of using a device or the like that automatically coats the protective film 43, the structure of the device can be simplified.

### EXAMPLE

Hereinafter, examples are described in more detail, but the disclosure is not limited to the following examples.

TABLE 1

| | | Resistance value of upper electrode [Ω] | | | |
|---|---|---|---|---|---|
| | Protective | 100 hours | 200 hours | 300 hours | 400 hours |
| | film | later | later | later | later |
| Example 1 | Flux | 0.4 | 0.3 | 0.3 | 0.4 |
| Example 2 | Adhesive | 0.4 | 0.4 | 0.4 | 0.4 |
| Example 3 | PET film | 0.4 | 0.4 | 0.4 | 0.4 |
| Example 4 | Fluorine | 0.4 | 0.4 | 0.7 | — |
| | coating | | | | |
| Comparative | No | 0.4 | — | — | — |
| Example | | | | | |

As shown in Table 1, in the piezoelectric element 4 of Example 1, the protective film 43 was formed by applying the above-mentioned commercially available flux to the upper electrode 42, and in the piezoelectric element 4 of Example 2, the protective film 43 was formed by applying a commercially available adhesive to the upper electrode 42. In the piezoelectric element 4 of Example 3, a commercially available PET (polyethylene terephthalate) film was cut into a circular shape, and the protective film 43 was created by adhering the outer edge of the cut film to the periphery of the upper electrode 42 (lower electrode 40).

In the piezoelectric element 4 of Example 4, the protective film 43 was formed by applying a commercially available fluorine coating agent for electronic components to the upper electrode 42. The protective film 43 of the piezoelectric element 4 in Examples 1 to 4 was formed with the same coverage range as the protective film 43 described in the above embodiment (see the FIGURE).

The piezoelectric element of Comparative Example has the same configuration as the piezoelectric element 4, except that the protective film 43 is not formed. The piezoelectric elements 4 of Examples 1 to 4 and the piezoelectric element of Comparative Example were left for a long time in an environment where sulfurization (deterioration) of the electrodes tends to occur, and performance evaluation was conducted. As a result, as shown in Table 1, it was found that the piezoelectric elements 4 of Examples 1 to 4 were able to suppress sulfurization (deterioration) of the upper electrode 42 compared to the piezoelectric element of Comparative Example.

Although the disclosure has been described based on the above embodiments, the disclosure is not limited thereto, and it can be easily understood that various improvements and modifications may be made without departing from the spirit and scope of the disclosure.

In the above embodiment, the electronic cymbal 1 has been illustrated as an example of an electronic musical instrument to which the piezoelectric element 4 is attached, however, the piezoelectric element 4 may be attached to other electronic percussion instruments such as an electronic drum (electronic pad).

In the above embodiment, a case has been described in which the piezoelectric element 4 is formed of four layers including the lower electrode 40, the piezoelectric body 41, the upper electrode 42, and the protective film 43 (or five layers including the conductive adhesive that bonds the lower electrode 40 and the piezoelectric body 41), however, another layer may be interposed between each of the layers.

In the above embodiment, a case has been described in which the flux forming the protective film 43 is resin-based flux having rosin as a main component (main agent), however, the disclosure is not necessarily limited thereto. For example, the protective film 43 may be formed with resin-based (organic-based) flux having other resins such as synthetic resin as a main component, or the protective film 43 may be formed with inorganic-based flux such as boric acid-based or phosphoric acid-based flux. That is, other known flux can be used as long as the flux can form a coating that covers the upper electrode 42 after drying.

In the above embodiment, an adhesive, a PET film, a fluorine coating agent, and the like have been illustrated as materials other than flux for forming the protective film 43, however, the disclosure is not necessarily limited thereto. For example, the protective film 43 may be formed using a known sealing agent such as an anti-corrosion spray, paint, wax, coating agent, film or tape, or an epoxy resin or UV curing resin.

Furthermore, the protective film 43 is not limited to insulating materials and may be formed using a conductive material such as metal. When such a conductive material is used, the protective film 43 may be formed in a range that does not cause short-circuiting between the upper and lower electrodes 40 and 42. As an example of a method for forming the protective film 43 using a conductive material, a method for forming a metal coating on the upper electrode 42 by solder or sputtering is illustrated. That is, the material and formation method of the protective film 43 are not limited to the above forms as long as the material and formation method can prevent corrosion (for example, sulfurization) of the upper electrode 42.

In the above embodiment, a case has been described in which the entire upper electrode 42 including the connection portion between the upper electrode 42 and the conductor wire 10b (the entire solder 9b) is covered with the protective film 43, however, the disclosure is not necessarily limited thereto. For example, a configuration in which merely the upper surface of the upper electrode 42 is covered by the protective film 43 (the upper surface of the solder 9b is exposed from the protective film 43) may be adopted.

In the above embodiment, a case has been described in which the flux is applied to the upper electrode 42 after soldering the conductor wire 10b to the upper electrode 42, however, the conductor wire 10b may be soldered after the flux is applied to the upper electrode 42.

What is claimed is:

1. A piezoelectric element, attached to an electronic percussion instrument, comprising:
a lower electrode;
a piezoelectric body, stacked on the lower electrode;
an upper electrode, stacked on the piezoelectric body; and
a protective film, covering the upper electrode and protecting the upper electrode from gas surrounding the upper electrode.

2. The piezoelectric element according to claim 1, wherein
a main component of the protective film is rosin.

3. The piezoelectric element according to claim 1, further comprising:
a conductor wire, connected to the upper electrode, and
the entire upper electrode including a connection portion between the upper electrode and the conductor wire being covered by the protective film.

4. The piezoelectric element according to claim 1, wherein
a thickness of the protective film is 4 μm or more and 30 μm or less.

5. The piezoelectric element according to claim 1, wherein
a metal material of the upper electrode contains copper, nickel or palladium.

6. An electronic percussion instrument, comprising:
the piezoelectric element according to claim 1; and
a rubber cover, covering a space in which the piezoelectric element is housed, and a strike being detected based on an output value of the piezoelectric element.

7. The electronic percussion instrument to claim 6, wherein
a main component of the protective film is rosin.

8. The electronic percussion instrument according to claim 6, further comprising:
a conductor wire, connected to the upper electrode, and
the entire upper electrode including a connection portion between the upper electrode and the conductor wire being covered by the protective film.

9. The electronic percussion instrument according to claim 6, wherein
a thickness of the protective film is 4 μm or more and 30 μm or less.

10. The electronic percussion instrument according to claim 6, wherein
a metal material of the upper electrode contains copper, nickel or palladium.

11. A method for manufacturing a piezoelectric element attached to an electronic percussion instrument, comprising:
a lamination process of forming a laminate in which a lower electrode, a piezoelectric body stacked on the lower electrode, and an upper electrode stacked on the piezoelectric body are stacked; and
a coating process of coating the upper electrode of the laminate formed in the lamination process with a protective film for protecting the upper electrode from gas surrounding the upper electrode.

12. The method for manufacturing a piezoelectric element according to claim 11, wherein
in the coating process, the protective film is formed by applying flux having rosin and solvent as main components to the upper electrode.

13. The method for manufacturing a piezoelectric element according to claim 12, wherein
the flux used in the coating process contains 20 wt % to 40 wt % of the rosin and 60 wt % to 80 wt % of the solvent.

14. The method for manufacturing a piezoelectric element according to claim 12, further comprising:
a connection process of soldering a conductor wire to the upper electrode of the laminate formed in the lamination process; and
the coating process performed after the connection process.

15. The method for manufacturing a piezoelectric element according to claim 11, wherein
a thickness of the protective film is 4 μm or more and 30 μm or less.

16. The method for manufacturing a piezoelectric element according to claim 11, wherein
a metal material of the upper electrode contains copper, nickel or palladium.

17. A method for manufacturing an electronic percussion instrument having a housing and a piezoelectric element attached to the housing, comprising:
a lamination process of forming a laminate in which a lower electrode, a piezoelectric body stacked on the lower electrode, and an upper electrode stacked on the piezoelectric body are stacked; and
a coating process of forming the piezoelectric element by coating the upper electrode of the laminate formed in the lamination process with a protective film for protecting the upper electrode from gas surrounding the upper electrode; and
a mounting process of attaching the piezoelectric element formed in the coating process to the housing.

18. The method for manufacturing an electronic percussion instrument according to claim 17, wherein
in the coating process, the protective film is formed by applying flux having rosin and solvent as main components to the upper electrode.

19. The method for manufacturing an electronic percussion instrument according to claim 18, wherein
the flux used in the coating process contains 20 wt % to 40 wt % of the rosin and 60 wt % to 80 wt % of the solvent.

20. The method for manufacturing an electronic percussion instrument according to claim 18, further comprising:
a connection process of soldering a conductor wire to the upper electrode of the laminate formed in the lamination process; and
the coating process performed after the connection process.
